(19) United States
(12) Patent Application Publication
(10) Pub. No.: US 2007/0271163 A1
(43) Pub. Date: Nov. 22, 2007

(54) Method for Using Options on Housing Futures Contracts to Offer Home Price Insurance

(76) Inventor: Bradley John Schaufenbuel, Downers Grove, IL (US)

Correspondence Address: BRADLEY JOHN SCHAUFENBUEL, 5009 CORNELL AVENUE, DOWNERS GROVE, IL, 60515-4314, US

(21) Appl. No.: 11/419,502

(22) Filed: May 21, 2006

(51) Int. Cl. G06Q 40/00

(52) U.S. Cl. 705/35

(57) ABSTRACT

A home price insurance policy offers a homeowner the ability to insure himself or herself against losses incurred due to falling home prices between the time the policy is purchased and the time the insured's home is sold (if the policy is still in effect). In order to offer such a policy at an affordable premium, an insurer must be able to minimize its losses (claims paid) should the risk event (prices are lower when the home is sold and the policy is in effect) crystallizes. This invention provides a method for using put options on housing futures contracts to price a home price insurance policy appropriately today and hedge claims risks in the future.

### BACKGROUND OF THE INVENTION

Like any asset, homes fluctuate up and down in value (price) in response to market conditions. A home purchaser faces the risk that the value of that home will fall between the time of purchase and the time of sale. To mitigate market risk, a buyer might want to transfer the risk to an insurer through an insurance policy.

An insurance policy that insures a homeowner against loss incurred on the basis of falling home prices is called a “Home Price Insurance” policy. In consideration for a premium payment or payments, an insurer agrees to reimburse the insured if home prices in the area fall between the time the insurance policy goes into affect and the time the house is sold (if the policy is in effect).

In order to offer such a policy profitably to homeowners, an insurance company must overcome the problems of “uniqueness”. Uniqueness means that each home is different and each seller's situation is different. The uniqueness of each home makes its individual marketability difficult to measure and predict. The value of an individual house may not move in parallel with other homes in the same area. The uniqueness of each seller's situation means that the final sales price can differ drastically based on the homeowner's urgency to move, flexibility in negotiations, etc. These factors are beyond the influence of the insurer.

To overcome this problem, a home price insurance policy should not rely upon the purchase and sale price of an individual home, but on changes in an aggregate local property index during the duration of ownership. Examples of such indexes are those maintained by S&P Case-Shiller for ten major U.S. metropolitan areas.

To illustrate, imagine that a man purchases a home in Chicago, Ill. for $300,000. He simultaneously purchases a five year home price insurance policy. During the fifth year that the policy is in effect, he sells his house. During the time that the man owns the house, the Chicago housing price index has dropped by five percent. The man could file a claim against the home price insurance policy for $15,000 to recoup some or all of his actual losses.

### BRIEF SUMMARY OF THE INVENTION

To be successful and remain solvent, an insurer must ensure that its policies are priced appropriately and that its claims risk is effectively managed. This invention provides a method for utilizing put options on futures contracts to solve both of these problems for home price insurance policies.

As with any insurance policy, the premium must be sufficient to cover overhead expenses, pay future claims, and earn a profit. The key unknown element is the amount and size of claims that will be filed in the future. Since there is no way for an insurance company to know where home prices will be in the future, the insurer does not know what the number and size of claims will be at the time the policy is issued, making it difficult to know how large the premium that it charges must be. This invention provides a method for determining the portion of a premium needed to cover future claims based on the cost of the options on housing futures contracts that are needed to hedge the risk.

Once any insurance policy is sold, an insurer must manage its claims risk by employing means to reduce losses that result from making claims payments. Insurance companies typically manage this risk by accepting it, transferring it to another entity (reinsurance), or hedging it (through financial derivatives). This invention provides a method for solving this problem by hedging claims risk through the use of put options on housing futures contracts.

### BRIEF DESCRIPTION OF THE SEVERAL VIEWS OF THE DRAWING

FIG. 1 is a flow chart that depicts the process of using the cost of put options on housing futures contracts to help determine the premium an insurer should charge a customer for a home price insurance policy.

FIG. 2 is a flow chart that depicts the process an insurer would utilize to hedge claims risk on a home price insurance policy using put options on housing future contracts.

### DETAILED DESCRIPTION OF THE INVENTION

To determine the premium that should be charged for a home price insurance policy, an insurer needs to determine its overhead in offering and servicing the policy, its desired profit margin, and its claims liability. The premium charged should be an aggregate of these items:

Overhead+Desired Profit+Claims Liability=Premium

Reserves are defined as the funds that an insurance company sets aside to settle potential claims. Exposure is defined as the losses that an insurer is likely to endure due to claims liability. The greater an insurer's exposure, the higher the insurer's reserves need to be to maintain solvency. The more money that an insurer has tied up in reserves, the less money it has to invest, resulting in lower profitability. So lowering exposure leads to lower premiums and greater profitability.

To lower an insurer's exposure, a method of using options on housing futures contracts to hedge claims risk is proposed. The method is described as follows:

When a potential customer requests a rate quote for a home price insurance policy, he or she specifies the coverage amount (typically the value of the home), the maximum term of the policy, and the metropolitan location of the property. For the purposes of illustration, let us imagine that the customer is purchasing a $300,000 home in the Chicago metropolitan area and wants coverage for a term of five years.

The insurer then utilizes this information to price put options on housing futures contracts with an aggregate size equal to that of the coverage amount and a length equal to the maximum term of the policy. Returning to our scenario, let us say that the S&P/Case-Shiller Home Price Index for the Chicago metropolitan area is currently at 200. The multiplier for housing futures contract offered by the Chicago Mercantile Exchange is $250. The insurer would therefore price six put options on housing futures contracts with strike prices at today's prevailing market price ($250×200×6=$300,000) and expiration dates 60 months into the future. For illustration purposes, let's say that such options on futures contracts are currently selling for $500 a piece. The insurer would therefore pay $3,000 for these options. Let's also imagine that the insurer estimates that another $1,000 would be needed to cover all other overhead expenses and provide an adequate profit margin. The insurer would therefore offer the policy for a premium of $4,000.

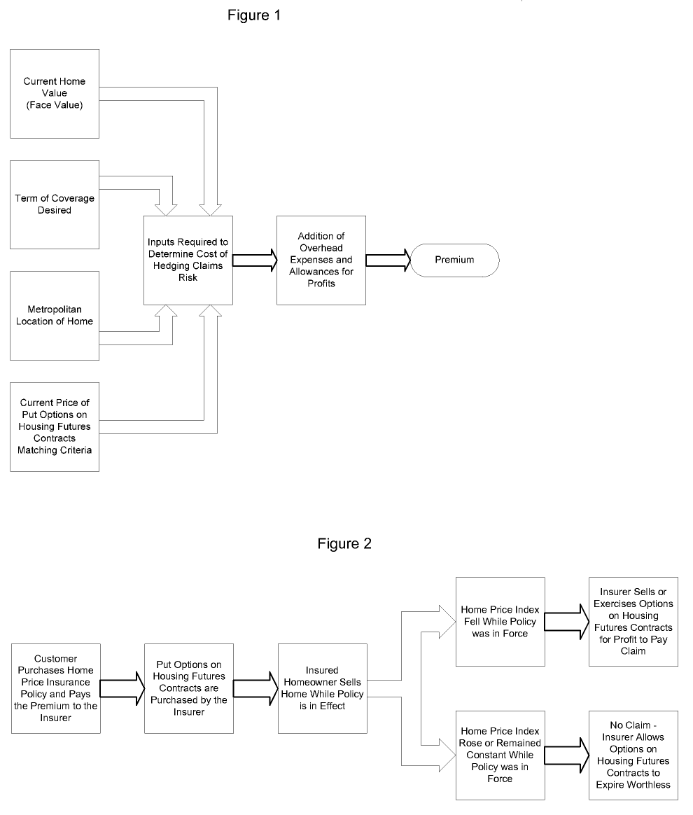

The aforementioned process for using put options on housing future contracts in the determination of home price insurance premiums is depicted in FIG. 1.

Assuming that the homeowner purchases the home price insurance policy, the insurer now needs to manage its claims risk. The proposed method of doing this is for the insurance company to utilize the premium payment to purchase put options on futures contracts with the specifications used initially to price the policy. In the example, the insurer would purchase six options on housing futures contracts with an expiration date 60 months into the future for the Chicago Metropolitan Area from the Chicago Mercantile Exchange for $3,000.

If the housing price index remains constant or rises during the term of the policy (defined as the period between the purchase of the policy and the sale of the home or the purchase of the policy and its expiration), then the put options on futures contracts are allowed to expire worthless. (The value of the options will be zero and exercising them would result in the insurer purchasing housing future contracts above their market value, creating losses).

If the housing price index falls during the term of the policy, the put options on housing futures contracts are exercised or sold, and the profits from the transaction are utilized to pay the insured's claims. (The value of the options will be greater than zero and exercising the options will result in the insurer purchasing housing futures contracts below their market value, resulting in gains).

The aforementioned process for using put options on housing futures contracts to manage the claims risk of an in-force home price insurance policy is depicted in FIG. 2.

The embodiments of the invention in which an exclusive property or privilege is claimed are defined as follows:

What is claimed is:

1. A method for using options on housing futures contracts to determine the premium an insurer will quote its customer that is comprised of the following steps: (a) Using the inputs of a potential customer's current home value, term of policy, and location of home, an insurer prices put options on housing futures contracts in the same metropolitan area and with the with the same duration and value; (b) The insurer then adds desired profit and estimated overhead expenses to the cost of the options on housing futures contracts to determine the premium to be charged to the customer.

2. A method for using put options on housing futures contracts to hedge the claims risk of a home price insurance policy that is comprised of the following steps: (a) If the customer purchases the home price insurance policy, the insurer actually purchases the put options on housing futures contracts that were priced to determine the premium in claim 1; (b) If the housing price index for the metropolitan area covered increases or remains the same during the term of the policy, the insured is entitled to no claims and the insurer allows the put options on housing futures contracts to expire worthless; (c) If the housing price index for the metropolitan area covered decreases and the house is sold during the term of policy, the insurer will either sell the put options on housing futures contracts or exercise them and utilize the profits to pay the insured's claims.
